(19) United States
(12) Patent Application Publication
(10) Pub. No.: US 2017/0318985 A1
(43) Pub. Date: Nov. 9, 2017

(54) SHELF PARTITION FOR DISPLAYING BAGGED FOOD ITEMS AND METHOD OF USING THE SAME

(71) Applicant: Post Consumer Brands, LLC, Lakeville, MN (US)

(72) Inventor: Stephen Robert Collette, Lakeville, MN (US)

(21) Appl. No.: 15/146,349

(22) Filed: May 4, 2016

(51) Int. Cl. A47F 5/00; A47F 7/28; A47F 7/00; G09F 3/20; A47F 5/10

(52) U.S. Cl. CPC A47F 5/005; G09F 3/204; A47F 5/105; A47F 7/0071; A47F 7/281

(57) ABSTRACT

A shelf partition for containing and displaying bagged bulk food on point-of-sale shelving has a front panel and an adjustable length side panel. The front panel has at least a translucent front portion. The translucent front portion has a convex outer face adapted to magnify a flat image when the flat image is positioned behind the front portion of the front panel. The adjustable length side panel is connected to the front panel. The front face portion of the front panel and at least a first portion of the side panel are integrally formed as a monolithic and homogenous injection molded piece.

### CROSS-REFERENCE TO RELATED APPLICATIONS

Not Applicable.

### STATEMENT REGARDING FEDERALLY SPONSORED RESEARCH OR DEVELOPMENT

Not Applicable.

### APPENDIX

Not Applicable.

### BACKGROUND OF THE INVENTION

### Field of the Invention

The present invention pertains generally to shelf partitions for displaying bagged food items. More particularly, the present invention pertains to an L-shaped adjustable shelf partition that also serves as an advertisement fixture.

### General Background

It is becoming increasing common to package and sell particular bulk food items in plastic bags. For example, many breakfast cereals are now sold in bags rather than boxes. Other bulk food items are also sold in bags (e.g., rice). It should be appreciated that such bags of packaged food products are pliable and deformable, albeit they maintain substantial constant volume. In general, it is impractical to arrange bagged food items on a point-of-sale shelf in a manner such that particular printing on the bags face store patrons. Thus, it can be difficult for patrons to quickly discern what brand of product is provided in the bags. It is therefore common to mount partitions/dividers on shelves to separate and isolate different brands and/or sizes of bagged food items in partitioned compartments and to put other signage near each partitioned compartment for the purpose of identifying and advertisement the bagged food items. In some cases, such signage is attached to or provided on the partitions themselves. The present invention improves upon known prior art shelf partitions for bags of bulk food.

### SUMMARY OF THE INVENTION

In a first aspect of the invention, a shelf partition for containing and displaying bagged bulk food on point-of-sale shelving comprises a front panel and an adjustable length side panel. The front panel comprises at least a translucent front portion. The translucent front portion has a convex outer face. The front portion of the front panel is configured and adapted to magnify a flat image when the flat image is positioned behind the front portion of the front panel. The adjustable length side panel is connected to the front panel.

In another aspect of the invention, a shelf partition for containing and displaying bagged bulk food on point-of-sale shelving comprises a front panel and an adjustable length side panel. The adjustable length side panel is connected to the front panel. At least a first portion of the front panel and at least a first portion of the side panel are integrally formed as a monolithic and homogenous injection molded piece, the shelf partition has an L-shape in plan view.

In yet another aspect of the invention, a method of displaying bagged bulk food on point-of-sale shelving comprises attaching a first shelf partition to a point-of-sale shelf. The shelf has a front edge and a back edge. The first shelf partition comprises a front panel and an adjustable length side panel. The adjustable length side panel is connected to the front panel and at least a first portion of the front panel and at least a first portion of the side panel are integrally formed as a monolithic and homogenous injection molded piece. The first shelf partition has an L-shape in plan view. The front panel is placed adjacent to the front edge of the shelf. The side panel has a rear end that is adjacent to the back edge of the shelf. The method also comprises attaching a second shelf partition to the shelf. The second shelf partition is identical to the first shelf partition and comprises a front panel and an adjustable length side panel. The front panel of the second shelf partition is adjacent to the rear edge of the shelf. The side panel of the second shelf partition has a rear end that is adjacent to the front edge of the shelf. The front panels of the first and second shelf partitions are positioned between the side panels of the first and second shelf partitions. The method further comprises placing bagged bulk food on the shelf between the side panels of the first and second shelf partitions and partially behind the front panel of the first shelf partition.

Further features and advantages of the present invention, as well as the operation of the invention, are described in detail below with reference to the accompanying drawings.

### BRIEF DESCRIPTION OF THE SEVERAL VIEWS OF THE DRAWING

FIG. 1 depicts a perspective view of a plurality of shelf partitions in accordance with the invention attached to a point-of-sale shelf with bagged bulk food packages placed on the self therebetween.

FIG. 2 depicts a perspective view of one of the shelf partitions, with the side panel of the shelf partition in an extended configuration.

FIG. 3 depicts another perspective view of one of the shelf partitions, with the side panel of the shelf partition in an un-extended configuration.

FIG. 4 depicts an exploded perspective view of the shelf partition as shown in FIG. 3, except with the support wall of its front panel and product advertisement shown detached from the shelf partition.

FIG. 5 depicts a detail horizontal cross-section of the shelf partition taken about a horizontal plane that intersects one of the locking formations of the support wall of the shelf partition.

FIG. 6 depicts a detail vertical cross-section of the side panel of the shelf partition showing one set of the interlocking formations between the first and second portions of the side panel.

Reference numerals in the written specification and in the drawing figures indicate corresponding items.

### DETAILED DESCRIPTION

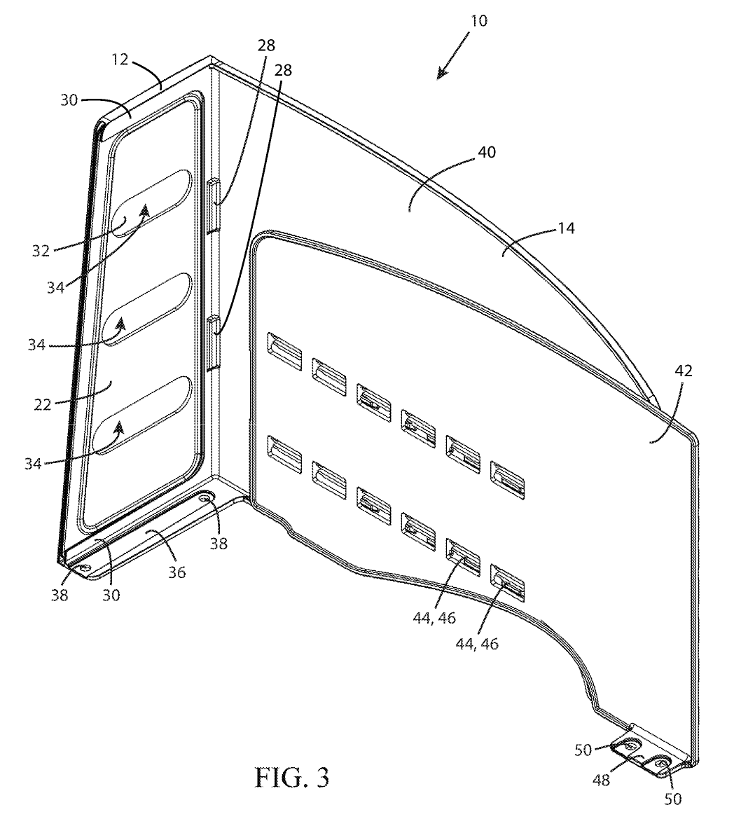

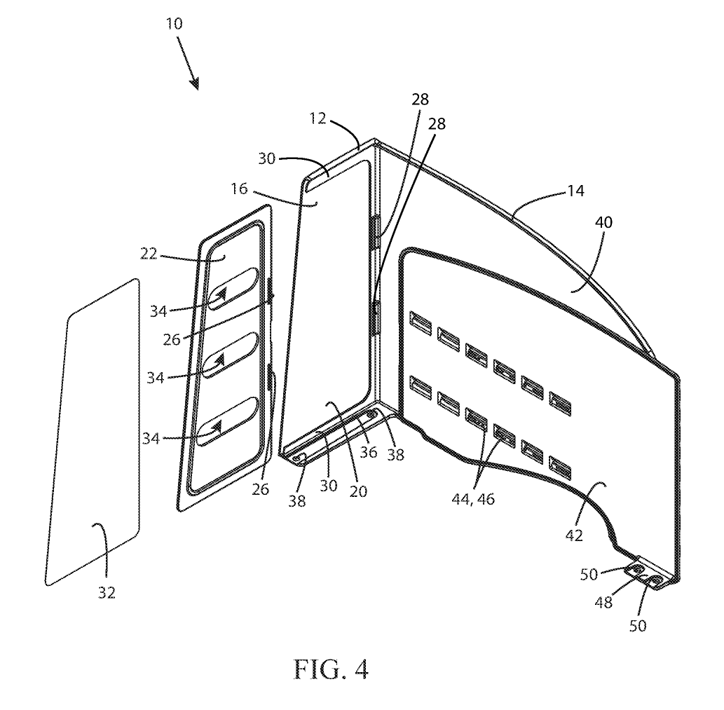

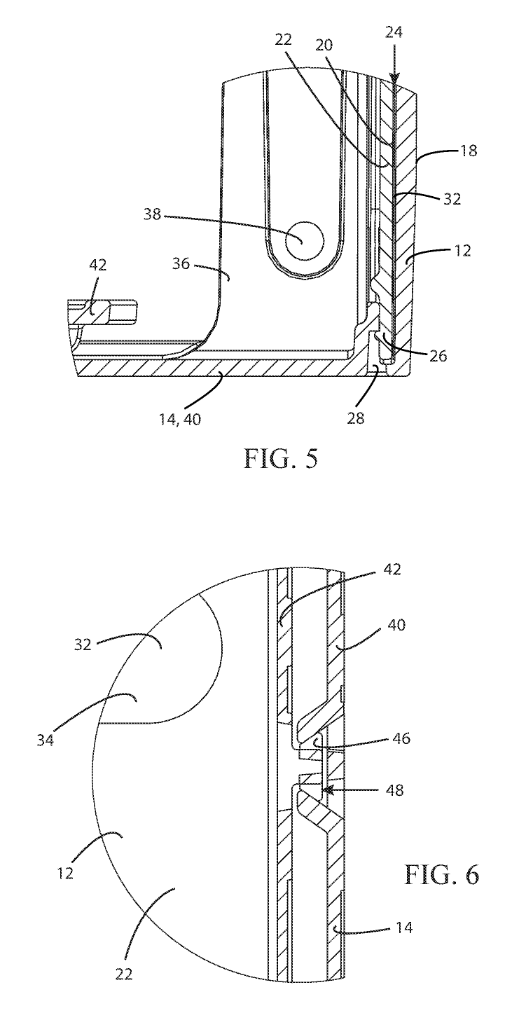

An embodiment of a shelf partition (10) for separating and displaying bagged bulk food on point-of-sale shelving in accordance with the invention is shown in FIGS. 2-4. The shelf partition (10) comprises a front panel (12) and an adjustable length side panel (14). The front panel (12) and the side panel (14) are connected to each other in a manner such that the shelf partition (10) is L-shaped in plan view (i.e., when viewed from directly above).

The front panel (12) comprises a translucent (and preferably transparent) front portion (16) that has a slightly convex outer surface (18). The back (20) of the front portion (16) is preferably flat. As such, the front portion (16) of the front panel (12) is configured to magnify what is behind the front portion of the front panel. The front panel (12) also comprises a support wall member (22) that that is spaced behind the front portion (16) of the front panel in a manner forming a pocket (24) between the front portion and the support wall member. The support wall member (22) is preferably formed separate from the remainder of the front panel (12) but is preferably configured to interlock with the remainder of the front panel via tabs (26) and slots (28). Once secured to the remainder of the front panel (12) via the tabs (26) and slots (28), the support wall member (22) is held generally parallel to the front portion (12) of the front panel by rails (30) that extend horizontally along the top and bottom of the front portion. The pocket (24) between the front portion (16) and the support wall member (22) of the front panel (12) is open along its rightmost end. As such, an advertisement member (32) can be slid into the pocket (24) where it will visible through the translucent front portion (16) of the front panel (12). The advertisement member (32) may be printed paper, cardboard, or any sheet material. The front portion (16) and support wall member (22) of the front panel (12), and the advertisement member (32) preferably all have generally the same perimeter shape and size. Preferably that perimeter shape is trapezoidal as shown, with horizontal top and bottom edges, a vertical left edge, and a sloped right edge. The support wall member (22) also preferably comprises at least one opening (34) that provides a finger hole to facilitate the removal of the advertisement member (32) from the pocket (24) of the front panel (12). The primary purpose of the of the support wall member (22) is to hold the advertisement member (32) against the front portion (16) of the front panel (12) and to prevent inadvertant removal of the advertisement member from the shelf partition (10) when bagged bulk food packages slide against the back of the front panel. The base of the front panel (12) also preferably comprises a support foot (36) that has a plurality of through-holes (38) that are configured to receive fasteners (not shown) for securing the shelf partition (10) to a point-of-sale shelf, as is explained in greater detail below.

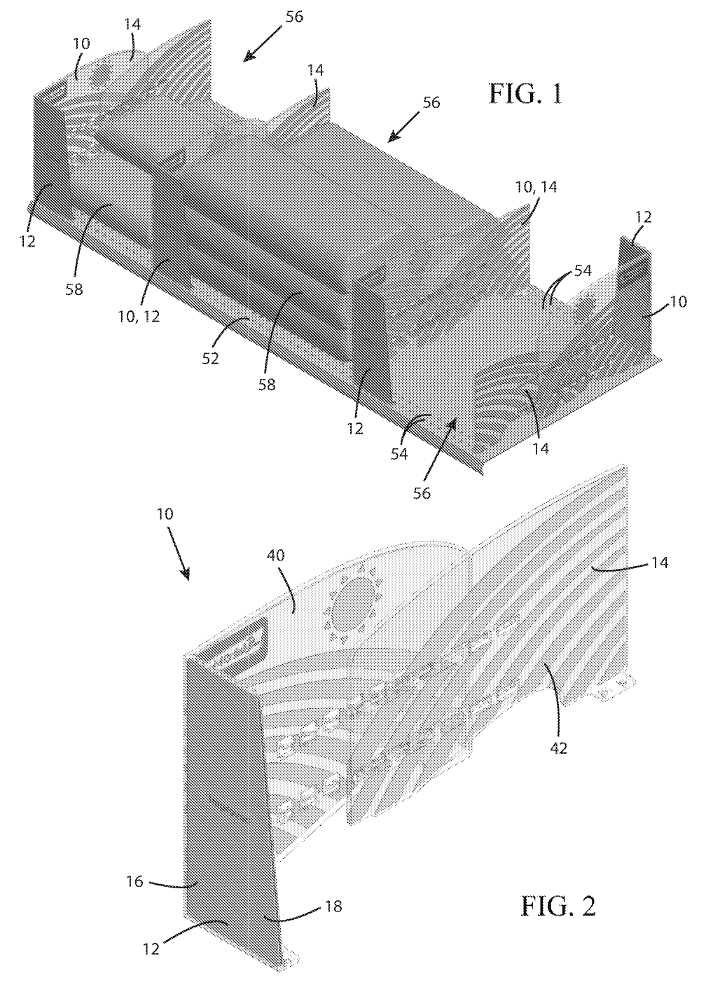

The side panel (14) of the shelf partition (10) preferably comprises first (40) and second (42) portions that are slideably connected to each other in a manner allowing the length (depth) of the side panel to be adjusted prior to attaching the shelf partition to a point-of-sale shelf. The first portion (40) of the side panel (14) is preferably formed integrally with the front portion (16) of the front panel (12) as a monolithic and homogenous injection molded piece of polycarbonate. The second portion (42) of the side panel (14) is preferably interlocked to the first portion (40) of the side panel via a plurality of slots (44) and tabs (46) that prevent relative movement between the first and second portions, except for horizontal relative movement parallel to the length of the side panel. Thus, prior to being fully attached to a shelf, the length/depth of the side panel (14) can be adjusted to match the depth of the shelf. The base of the second portion (42) of the side panel also preferably comprises a support foot (48) having a plurality of through-holes (50) configured to receive fasteners (not shown) for securing the shelf partition (10) to a point-of-sale shelf. As shown in FIGS. 1 and 2, the first (40) and second (42) portions of the side panel (14), preferably have perimeters and textured surfaces that themselves may resemble the trademark(s) associated with the bagged bulk food the shelf partition (10) is configured to separate and display.

In use, shelf partitions (10) configured as described above are attached to a point-of-sale shelf (52) as shown in FIG. 1. This is done be inserting press fittings through the through-holes (38, 50) of the support feet (36, 48) of the front and side panels and into the standard holes (54) typically provided on such a point-of-sale shelf (52). The adjustability of the length of the side panel (14) of each shelf partition (10) allows the shelf partition to be set to the depth of the shelve (52) (which is typically somewhere from fourteen to twenty eight inches). As shown in FIG. 1, the front panels (12) of the shelf partitions (10) are typically oriented facing the side of the shelf that faces a store aisle. However, in situations where it is desired to store/display bagged products adjacent to a right side edge of a shelf (52), the right-most shelf partition (10) can be reversed (i.e., attached to the shelf with the front panel (12) of said shelf partition adjacent the rear of the shelf) such that the side panel (14) of the shelf partition can be in close proximity to the right edge of the shelf (as shown in FIG. 1). As is shown in FIG. 1, the shelf partitions (10) can thereby form partitioned compartments (56) for storing and displaying bags (58) of bulk food or other bagged bulk items. Preferable the shelf partitions (10) are spaced from each other along the shelf (52) in a manner such that bags (58) of bulk food or other items fit snugly between the shelf partitions. As such, the front panels (12) of the shelf partitions (10) help prevent such bags (58) from inadvertently siding off of the shelf (52). When replacing one type of bagged food products (58) with another, the spacing between the shelf partitions (10) can be adjusted (if needed) any relevant advertisement member (32) can easily and quickly be replaced by sliding the advertisement member out of the pocket (24) of the front panel (12).

In view of the foregoing, it should be appreciated that the invention has several advantages over the prior art.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

It should also be understood that when introducing elements of the present invention in the claims or in the above description of exemplary embodiments of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations. Still further, the order in which the steps of any method claim that follows are presented should not be construed in a manner limiting the order in which such steps must be performed, unless such an order is inherent or explicit.

1. A shelf partition for containing and displaying bagged bulk food on point-of-sale shelving, the shelf partition comprising a front panel and a side panel, the front panel comprising a front portion, the side panel being connected to the front panel, the side panel being adjustable between a first length and a second length, the second length being greater than the first length, each of the front panel and the side panel comprising a support foot, each support foot having at least one through-hole adapted to receive a fastener such that the shelf partition can be removably secured to point-of-sale shelving.

2. A shelf partition in accordance with claim 1 wherein the front portion of the front panel and at least a first portion of the side panel are integrally formed as a monolithic and homogenous injection molded piece.

3. A shelf partition in accordance with claim 1 wherein the side panel comprises a first side panel portion and a second side panel portion, the first side panel portion being connected to the front panel, the second side panel portion being slideably connected to the first side panel portion such that the side panel can be adjusted between the first and second lengths.

4. (canceled)

5. A shelf partition in accordance with claim 1 wherein the front panel further comprises a support wall, the front portion and the support wall collectively defining a pocket open on at least one side, the pocket being configured and adapted to removably receive and substantially encase a product advertisement.

6. A shelf partition in accordance with claim 5 wherein the support wall comprises at least one finger hole configured and adapted to facilitate the removal of said product advertisement from the pocket.

7. A shelf partition for containing and displaying bagged bulk food on point-of-sale shelving, the shelf partition comprising a front panel and an adjustable length side panel, the adjustable length side panel being connected to the front panel in a manner such that the shelf-partition has an L-shape in plan view, the adjustable length side panel being variable in length between a first length and a second length, the front panel comprising a transparent front portion and a support wall spaced from the front portion, the support wall being generally parallel to the front portion, the front portion and the support wall collectively defining a pocket open on at least one side, the pocket being configured and adapted to receive a product advertisement such that the product advertisement is substantially encased between the front portion and the support wall.

8. A shelf partition in accordance with claim 7 wherein the adjustable length side panel comprises a first side panel portion and a second side panel portion, the second side panel portion being slideably connected to the first side panel portion such that a length of the adjustable length side panel can be adjusted by sliding the second side panel portion horizontally relative to the first side panel portion.

9. A shelf partition in accordance with claim 8 wherein each of the front panel and the second side panel portion comprise a support foot, each support foot having at least one through-hole adapted to receive a fastener such that the shelf partition can be removably secured to point-of-sale shelving.

10. A shelf partition in accordance with claim 9 wherein, the transparent front portion of the front panel has a convex outer face, the transparent front portion of the front panel being configured and adapted to magnify a flat image when the flat image is positioned behind the transparent front portion of the front panel.

11. (canceled)

12. (canceled)

13. A shelf partition in accordance with claim 7 wherein the support wall comprises at least one finger hole that is configured and adapted to facilitate the removal of said product advertisement from the pocket.

14-16. (canceled)
